(19) United States
(12) Patent Application Publication
(10) Pub. No.: US 2009/0256766 A1
(43) Pub. Date: Oct. 15, 2009

(54) MOBILE PHONE ANTENNA INTEGRATED WITH BATTERY

(75) Inventor: Henryk BURY, Mielec (PL)

Correspondence Address: MATTHIAS SCHOLL, 14781 MEMORIAL DRIVE, SUITE 1319, HOUSTON, TX, 77079, US

(73) Assignee: BURY SP Z O.O., Mielec (PL)

(21) Appl. No.: 12/388,507

(22) Filed: Feb. 18, 2009

(30) Foreign Application Priority Data
Apr. 9, 2008 (EP) EP08460011

(51) Int. Cl. H01Q 13/10; H01M 14/00

(52) U.S. Cl. 343/767; 429/8

(57) ABSTRACT

A mobile phone antenna integrated with a battery, comprising: a plurality of battery electrodes; a dielectric layer separating the battery electrodes from one another; and a slot formed in the battery electrodes; wherein walls of the slot are parallel to each other and the electrodes with said slot are adapted to emit and receive electromagnetic waves.

### CROSS-REFERENCE TO RELATED APPLICATIONS

Pursuant to 35 U.S.C. §119 and the Paris Convention Treaty, this application claims the benefit of European Patent Application No. EP08460011 filed Apr. 9, 2008, the contents of which are incorporated herein by reference in their entirety.

### BACKGROUND OF THE INVENTION

1. Field of the Invention

This invention relates to a mobile phone antenna integrated with a battery.

2. Description of the Related Art

In recent decades, mobile phones have been subject to miniaturization. However, miniaturization of mobile phone components is limited by technological constraints. Therefore, a visible trend exists towards integration of mobile phone components so that the integrated parts occupy a smaller space within mobile phones than they would as separate parts. For example, a phone keypad has been integrated with phone display and provided in touch screen form. Similarly, resonance chambers of phone speakers have been designed in such a way that they also form an antenna. And other solutions, where the phone battery acts as a dipole antenna, are also known.

In particular, U.S. Pat. No. 6,700,491 describes a battery, the electrodes of which constitute a dipole antenna. A major problem of such an antenna is the need to use electronic circuits to connect the antenna to a transmitter or receiver of a mobile phone. Another major problem is a non-uniform density of the electromagnetic waves propagating omni-directionally.

In addition, WO 03/043101 describes a foil antenna glued to a mobile phone battery and having a wide radiation pattern. This antenna does not make use of the battery electrodes directly but is rather a separate component affixed to the battery.

### SUMMARY OF THE INVENTION

One objective of this invention is to provide a mobile phone antenna, comprising mobile phone battery electrodes, which ensures wide circular pattern of the electromagnetic wave generated by the antenna.

This objective is achieved by providing a mobile phone antenna integrated with the battery electrodes, comprising: a plurality of battery electrodes; a dielectric layer separating the battery electrodes from one another; and a slot formed in the battery electrodes; wherein walls of the slot are parallel to each other whereby adapting the electrodes to emit and receive electromagnetic waves.

In one class of this embodiment, the slot is a straight line, a curved line, or a broken line.

In another class of this embodiment, the antenna is open at one end or closed at both ends.

In another class of this embodiment, the antenna is formed by two or more slots of different geometry, adapted to different frequencies of the electromagnetic wave received or transmitted, corresponding to the frequencies, at which mobile phone transmitters or receivers operate, or it is formed by a slot cut in battery electrodes, stacked one on top of another, and in a dielectric separating these electrodes.

In another class of this embodiment, the slot is filled with air or a dielectric.

In another class of this embodiment, the width and length of the slot are related to the frequency of the electromagnetic waves.

In another class of this embodiment, the locations of transmission or reception of high-frequency signals in the antenna are related to the frequency of the electromagnetic waves.

In another class of this embodiment, the axis of symmetry of the slot is a straight line or a curved line.

In another class of this embodiment, the slot is comprised of a plurality of segments, each of the segments having a straight line axis of symmetry.

In another class of this embodiment, the slot is open at one end or closed at two ends.

In another class of this embodiment, the slot is comprised of two or more segments, each having a different geometry, wherein the segments are each adapted to a receiving and transmitting electromagnetic signals at different frequencies, the frequencies corresponding to frequencies at which mobile phone transmitters or receivers operate.

In another class of this embodiment, the battery electrodes are stacked on top of one another.

### BRIEF DESCRIPTION OF THE DRAWINGS

The mobile phone antenna integrated with a battery, according to the invention, is presented, by way of the example only, in the drawings, in which:

FIG. 1 shows a cross-section of a slot antenna according to a representative embodiment of the invention;

FIG. 2 shows a slot antenna formed in a single phone battery according to a representative embodiment of the invention;

FIG. 3 shows a top plan view of an antenna formed by a curved-line axis slot made in the battery electrodes according to a representative embodiment of the invention;

FIG. 4 shows a top view of an antenna formed by a slot in an electrode, the slot consisting of two segments, each of the segments having a straight line axis of rotation;

FIG. 5 shows a top plan view of a multi-frequency antenna formed by two slots in an electrode;

FIG. 6 shows an antenna formed by a slot made in a plurality of electrodes stacked on top of one another;

FIG. 7 is a chart showing the standing wave ratio (SWR) of an antenna according to a representative embodiment of the invention versus the frequency of the transmitted or received electromagnetic wave; and

FIG. 8 shows the intensity of an electromagnetic wave generated by the slot antenna according to a representative embodiment of the invention.

### DETAILED DESCRIPTION OF THE EMBODIMENTS

Detailed description will be given below with reference to accompanying drawings.

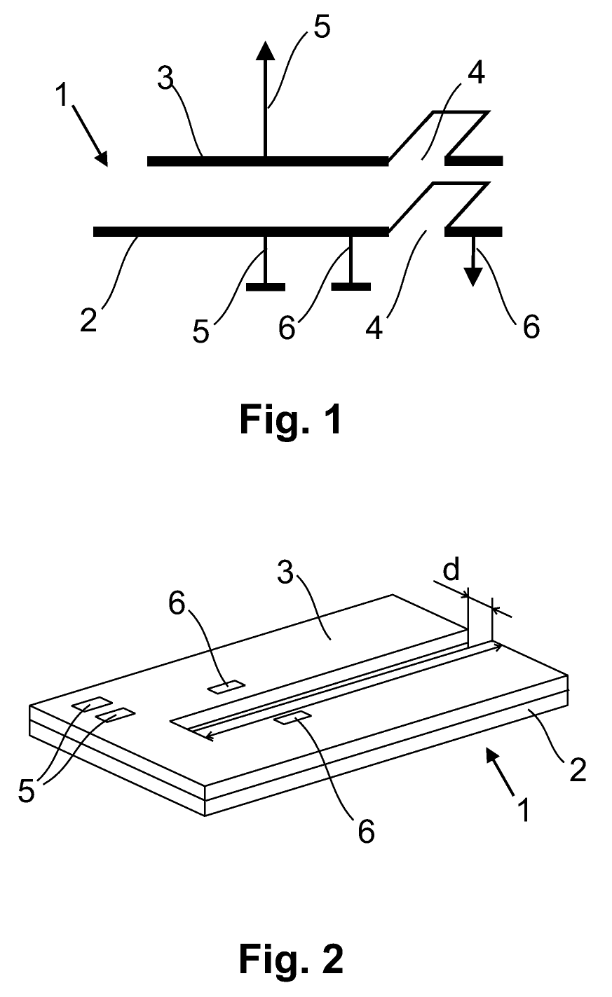

FIG. 1 shows an electric circuit schematic of the battery 1, comprising two electrodes 2 and 3 of opposite polarity, provided with a slot 4, forming the antenna. The electrode 2 is provided with antenna contacts 6, located on both sides of the slot 4 and both electrodes 2 and 3 of the battery 1 are provided with battery contacts 5.

FIG. 2 is a perspective view of a mobile phone antenna, comprising a slot 4 made in both electrodes 2 and 3 of the mobile phone battery 1 and dielectric layer 7 separating these electrodes. The antenna depicted in FIG. 2 has a slot 4, the axis of which is a straight line and which is open at one side. The walls of the slot 4 are parallel to each other. FIG. 2 shows also, an example of a layout of the battery contacts 5 and the antenna contacts 6.

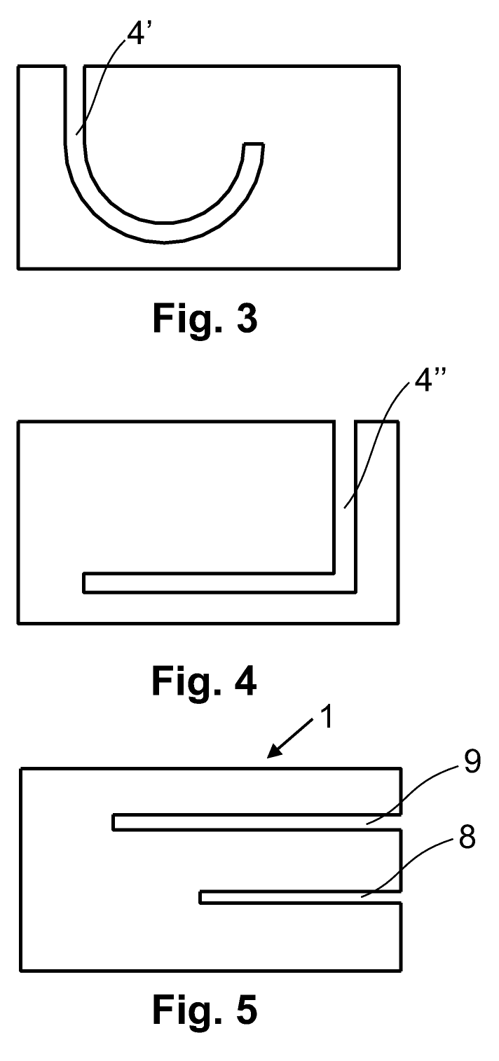

FIG. 3 is a top plan view of the antenna in which the gap 4′ has a curved-line axis, whereas FIG. 4 is a top plan view of an antenna in which the slot 4″ has a broken-line axis.

The dimensions of the slots 4, 4′ and 4″, namely the width d and the length 1, and the layout of antenna contacts 6 have a significant influence on the dominant electromagnetic wave transmitted or received by the antenna.

FIG. 5 shows the battery 1, comprising a set of two sub-antennas formed by slots 8 and 9 of different geometrical parameters, adapted to two different dominant frequencies of electromagnetic wave transmitted or received by the antennas. Particularly, slot 8 is adapted to the GSM frequency and slot 9 is adapted to the Bluetooth frequency.

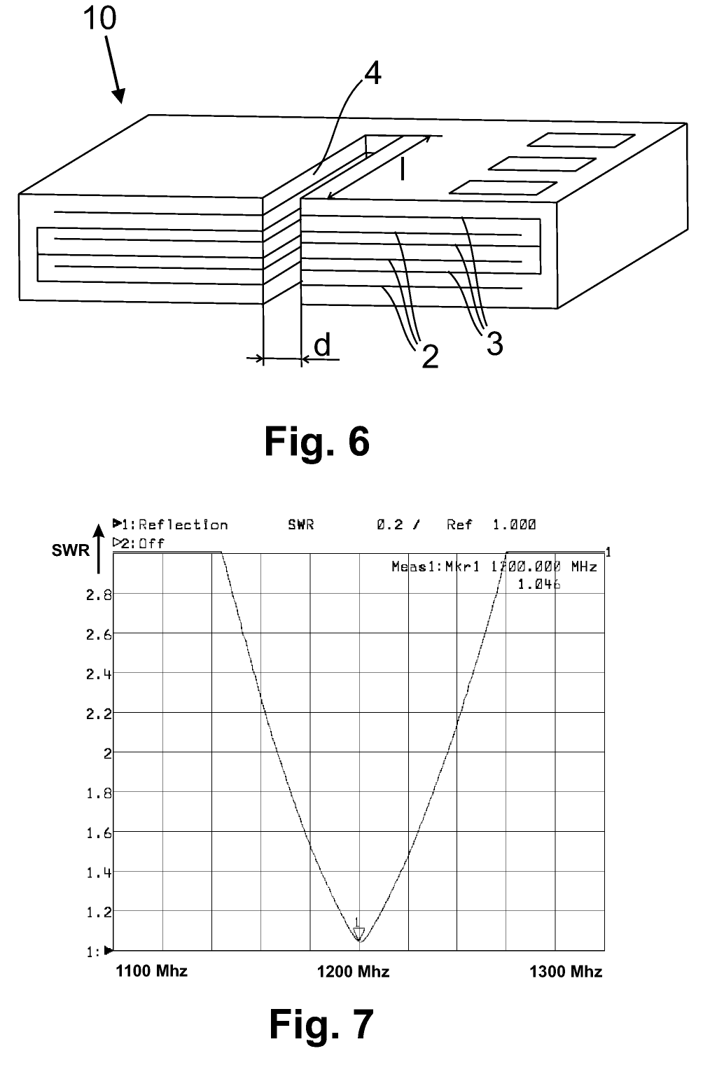

FIG. 6 shows an antenna formed as slot 4 made in the multiple-layer battery electrodes 2 and 3, stacked on one another.

FIG. 7 shows an example of the dependence between the SWR (standing wave ratio) of the slot antenna integrated with the battery and the frequency of the transmitted or received electromagnetic wave. The graph shows that curve reaches its minimum value at the SWR close to 1 for a frequency corresponding to a particular geometry of the slot. Proper values of the d and I parameters of the slot geometry may be obtained as a result of calculations and using computer software.

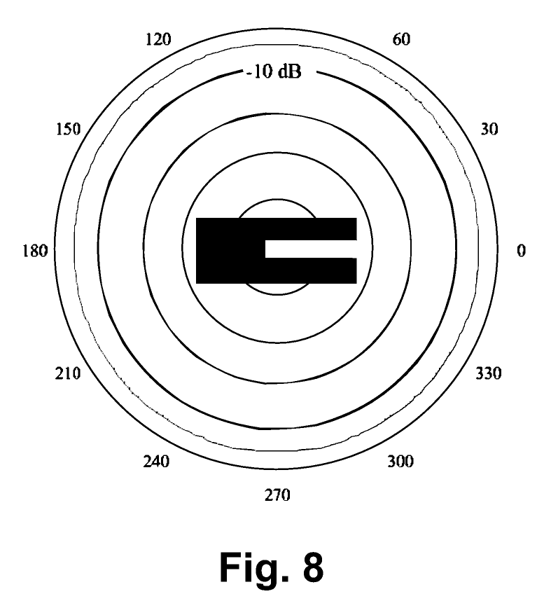

FIG. 8 is shows the intensity of an electromagnetic wave generated by the slot antenna integrated with battery. The graph shows that the antenna radiation intensity is uniform in all directions, in which the electromagnetic wave is generated.

This invention is not to be limited to the specific embodiments disclosed herein and modifications for various applications and other embodiments are intended to be included within the scope of the appended claims. While this invention has been described in connection with particular examples thereof, the true scope of the invention is not so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A mobile phone antenna integrated with a battery, comprising: a plurality of battery electrodes; a dielectric layer separating said battery electrodes from one another; and a slot formed in said battery electrodes; wherein walls of said slot are parallel to each other whereby adapting said electrodes to emit and receive electromagnetic waves.

2. The antenna of claim 1, wherein the width and length of said slot are related to the frequency of the electromagnetic waves.

3. The antenna of claim 1, wherein locations of transmission or reception of high-frequency signals are related to the frequency of the electromagnetic waves.

4. The antenna of claim 1, wherein an axis of symmetry of said slot is a straight line.

5. The antenna of claim 1, wherein an axis of symmetry of said slot is a curved line.

6. The antenna of claim 1, wherein said slot is comprised of a plurality of segments, each of said segments having a straight line axis of symmetry.

7. The antenna of claim 1, wherein said slot is open at one end.

8. The antenna of claim 1, wherein said slot is closed at two ends.

9. The antenna of claim 1, wherein said slot is comprised of two or more segments, each having a different geometry, wherein said segments are each adapted to a receiving and transmitting electromagnetic signals at different frequencies, said frequencies corresponding to frequencies at which mobile phone transmitters or receivers operate.

10. The antenna of claim 1, wherein said battery electrodes are stacked on top of one another.

11. The antenna of claim 1, wherein said slot is filled with air.

12. The antenna of claim 1, wherein said slot is filled with a dielectric.
